(19) United States
(12) Patent Application Publication
(10) Pub. No.: US 2014/0346957 A1
(43) Pub. Date: Nov. 27, 2014

(54) MEDICAL LIGHTING SYSTEM, IN PARTICULAR AN OPERATING LIGHTING SYSTEM, AND A METHOD OF CONTROLLING SUCH A LIGHTING SYSTEM

(71) Applicant: SURGIRIS, CROIX (FR)

(72) Inventors: Daniel MICUCCI, DOTTIGNIES (BE); Denis PAPIN, FRESNES SUR ESCAUT (FR)

(21) Appl. No.: 14/280,697

(22) Filed: May 19, 2014

(30) Foreign Application Priority Data
May 24, 2013 (FR) 13 54675

(51) Int. Cl. H05B 37/02

(52) U.S. Cl. CPC H05B 37/02
USPC 315/152

(57) ABSTRACT

The present invention provides a medical lighting system (1), in particular an operating lighting system, comprising: a set of light sources (2) for illuminating a determined area and having one or more modifiable optical properties; and a control device (6) for controlling the set of light sources (2), in order to modify said one or more optical properties as a function of a command from a user.

In particular, the control device (6) is a control device having a gestural interface and comprising:
two sensors (7, 8) mounted some distance from each other, each sensor delivering a signal corresponding to a detection zone and the detection zones of the two sensors (7, 8) including a common detection zone for detecting a gestural command from the user; and
analysis means receiving as input the signals coming from both of the sensors (7, 8) and configured to modify said one or more optical properties as a function of said gestural command.

The invention also provides a method of controlling such a lighting system (1).

### TECHNICAL FIELD

The present disclosure relates to a medical lighting system, in particular an operating lighting system, of the type emitting a light beam directed above an operative field without any shadows being cast, such a type of system being referred to as “scialytic”.

### BACKGROUND OF THE DISCLOSURE

A known medical lighting system comprises a set of light sources mounted some distance away from an operative field in such a manner as to illuminate a portion of the operative field with maximum light intensity, that portion being referred to as the “field of illumination”. Adjustment of the field of illumination, in particular focusing thereof, is performed either by the surgeon in person by means of a sterilizing handle mounted on the body of the light sources, or by an assistant on the instructions of the surgeon.

However, when the system is adjusted by the surgeon, the handle must be kept sterile throughout the entire operation. In addition, in order to take hold of the handle, the surgeon has to look towards the body of the light sources, i.e. into the light beam, and is therefore dazzled.

When the system is adjusted by an assistant, accurate adjustment of the field of illumination is made difficult by the position of said assistant who is some distance away from the surgeon, and therefore some distance away from the field of illumination to be adjusted. The adjustment is therefore made by following the instructions given by the surgeon, which takes longer and makes it less accurate.

### OBJECTS AND SUMMARY OF THE DISCLOSURE

An object of the present disclosure is to solve the various above-listed technical problems. In particular, an object of the present disclosure is to propose a medical lighting system that makes adjustment more flexible and more accurate for the user. Another object of the disclosure is to propose a medical lighting system that limits the sterility constraints on the user.

Thus, in one aspect, the disclosure provides a medical lighting system, in particular an operating lighting system, comprising:
a set of light sources for illuminating a determined area, e.g. an operative field, and having one or more modifiable optical properties; and
a control device for controlling the set of light sources, in order to modify said one or more optical properties as a function of a command from a user.

In particular, the control device is a control device having a gestural interface and comprising:
two sensors mounted some distance from each other, each sensor delivering a signal corresponding to a detection zone and the detection zones of the two sensors including a common detection zone for detecting a gestural command from the user; and
analysis means receiving as input the signals coming from both of the sensors and configured to modify said one or more optical properties as a function of said gestural command.

By means of the two-dimensional analysis of the common detection zone, the lighting system can be controlled easily and accurately by the surgeon in person. In particular the surgeon no longer needs to look up at the system, and to be dazzled during the operation. In particular, the surgeon can modify the focusing of the lighting, the brightness, the color, etc. by controlling the light sources, or by controlling optical elements, such as filters or optical surfaces, that can be positioned and moved electrically in the light beam coming from the light sources.

In addition, the use of two sensors that are spaced apart and that have a common detection zone, i.e. two sensors mounted in a stereoscopic relationship, makes it possible to analyze a gestural command in three dimensions, in space, and not merely in a plane. This makes it possible firstly to have a wider range of gestural commands, and secondly to distinguish between gestures performed in the work of the user, e.g. the gestures performed by the surgeon on the operative field, and the gestures performed by the user to control the lighting system.

A medical lighting system, in particular an operating lighting system (i.e. a system procuring lighting without any shadows being cast), is obtained that is easy for the surgeon to control without having to comply with any sterilization constraint.

Preferably, analysis means receive as input the signals coming from both of sensors, and they are configured to modify said one or more optical properties as a function of said gestural command when the gestural command is given within the common detection zone and at a distance from the determined area that is greater than a determined value.

In particular, the analysis means are configured not to modify said one or more optical properties as a function of said gestural command when the gestural command is given within the common detection zone and at a distance from the determined area that is less than a determined value.

In other words, the analysis means are configured to modify said one or more optical properties as a function only of gestural commands that are given at some distance from the determined area.

Preferably, the two sensors are cameras.

Preferably, the set of light sources comprise a central module having a plurality of light sources, and one or more auxiliary modules, each having a plurality of light sources. The auxiliary modules may be mounted to be stationary around the central module, e.g. in a honeycomb configuration, or to be hinged mechanically relative to the central module in such a manner as to be inclinable relative thereto.

Preferably, the analysis means comprise gestural command identification means for identifying the gestural command, which means receive as input the signals coming from both of the sensors, and they are configured to deliver a control signal.

The gestural command identification means may comprise:
gesture recognition means for recognizing the gesture, which means receive as input the signals coming from the sensors and are configured to deliver one or more signals identifying a gesture from the user within the common zone of the two sensors; and
command selection means for selecting the command, which means receive as input the signal(s) delivered by the gesture recognition means, and are configured to deliver the control signal corresponding to the gesture identified by the gesture recognition means.

Thus, identification of the gestural command takes place in two steps: firstly, gesture recognition means analyze the signals coming from two sensors in order to identify accurately the gesture that has been made within the common detection zone, and then the result of the gesture recognition means is sent to command selection means that associate the previously identified gesture with a predefined command. The more the gesture identification is accurate, the easier and quicker it is for the associated command to be identified.

Preferably, the gesture recognition means comprise:
overall perception means for identifying the elements present within the common detection zone, which means receive as input the signals from both of the sensors, and they are configured to deliver one or more first gesture recognition signals, preferably in the form of space-time histograms;
dynamic perception means for identifying movements within the common detection zone, which means receive as input the signals from both of the sensors, and they are configured to deliver one or more second gesture recognition signals, preferably in the form of space-time histograms; and
structural perception means for identifying shapes within the common detection zone, which means receive as input the signals from both of the sensors, and they are configured to deliver one or more third gesture recognition signals, preferably in the form of space-time histograms.

The use of perception means that deliver signals in the form of space-time histograms enables the signals coming from both of the sensors to be processed quickly and efficiently in real time. The perception means (overall, dynamic, and structural perception means) make it possible, in particular, to determine the pertinent information in the signals coming from both of the sensors, and to transmit it, e.g. in the form of space-time histograms, to the command selection means. In this way, the quantity of data transmitted to the command selection means is limited, thereby making it possible for processing by the command selection means to be faster and more efficient.

Preferably, the command selection means comprise activation means for authorizing identification of the command when the gestural command is given within the common detection zone and at a distance from the determined area that is greater than a determined value. The activation means enable the control device to distinguish between the gestures made by the user down at the determined area and the gestures made higher up that are attributed to gestural control. The activation means thus define an activation zone outside which the user's gestures are not taken into consideration. Only the gestures made in the activation zone are taken into account and identified as commands.

The analysis means may further comprise control means that receive as input the control signal delivered by the gestural command identification means and that are configured to modify said one or more optical properties as a function of said control signal. The control means make it possible to translate the command into control signals modifying the optical properties of the set of light sources. The control means may thus power or cease to power certain electric light sources. They may also cause an optical surface placed between the light sources and the operative field to move in order to change the focusing of the beam. They may also add or remove filters, or indeed power or cease to power specific light sources, e.g. sources having particular emission spectra.

Preferably, the control device further comprises sound information means for emitting a sound signal that is audible by the user and that, for example, indicates that a gestural command has been detected, or that a gestural command is expected. The sound information means make it possible to communicate with the user as regards whether or not the user's commands have been taken into account. As a result of these sound means being implemented, the user is not obliged to look at a screen or at monitoring lights in order to check that the user's commands have been analyzed and taken into account: a simple sound signal informs the user that a command has been taken into account so that, in the absence of such a sound signal, the user can perform the gestural command again so that it can be taken into account.

Preferably, the sound information means are configured to emit a sound signal that is audible by the user when the activation means authorize identification of the command. The sound information means then make it possible to inform the user that the gestures are accepted as being within the activation zone and that the gestural commands are being analyzed. Thus, in the absence of such a sound signal, the user can know that the gestures are not being taken into consideration by the control device. Conversely, when the sound signal is emitted, the user knows that the gestural command can be given and that it will be taken into account.

Preferably, the control device is configured to modify said one or more optical properties by individual or grouped modification of the light intensities of light sources. In which case, the modifications requested by the user are controlled electronically without any movement of the lighting system. It is thus possible for the response to the command to be faster, and for the lighting system to be simpler by not having any movement motor. Preferably, the lighting system further comprises an optical element mounted between some of the light sources and the determined area, the size and/or the shape of the determined area being modified by individual or grouped control of the light intensities emitted by said at least some of the light sources.

In another aspect, the disclosure also provides a control method for controlling a medical lighting system by means of a gestural interface, the medical system being, in particular, an operating lighting system, and comprising a set of light sources that are configured to illuminate a determined area and that have one or more modifiable properties. The method comprises the following successive steps:

a) a detection step of detecting a user's gestural command within a detection zone that is common to two different detection zones; and then

b) an analysis step of analyzing said gestural command in order to modify said one or more optical properties as a function of said gestural command.

Preferably, the analysis step of analyzing said gestural command modifies said one or more optical properties as a function of said gestural command when the gestural command is given within the common detection zone and at a distance from the determined area that is greater than a determined value.

In particular, the analysis step of analyzing said gestural command does not modify said one or more optical properties as a function of said gestural command when the gestural command is given within the common detection zone and at a distance from the determined area that is less than a determined value.

In other words, the analysis step modifies said one or more optical properties as a function only of gestural commands that are given at some distance from the determined area.

Preferably, the analysis step comprises:

b1) a gestural command identification step of identifying said gestural command.

Preferably, the gestural command identification step of identifying said gestural command comprises:

b11) a gesture recognition step of recognizing the gesture; and then

b12) a command selection step of selecting the command corresponding to the gesture identified in step b11).

Preferably, the gesture recognition step b11) comprises:
overall perception identifying the elements present within the common detection zone;
dynamic perception identifying movements within the common detection zone; and
structural perception identifying shapes within the common detection zone.

Preferably, the command selection step comprises an activation step authorizing identification of the command when the gestural command is given within the common detection zone and at a distance from the determined area that is greater than a determined value.

Preferably, the analysis step comprises an optical property modification step of modifying said one or more optical properties as a function of said gestural command.

Preferably, the method further comprises a sound information step during which a sound signal that is audible by the user is emitted for indicating, for example, that a gestural command has been detected, or that a gestural command is expected.

Preferably, the sound information step emits a sound signal that is audible by the user when the activation step authorizes identification of the command.

### BRIEF DESCRIPTION OF THE DRAWINGS

The present disclosure and its advantages can be better understood on reading the following detailed description of a particular embodiment given by way of non-limiting example and illustrated by the accompanying drawings, in which:

FIG. 1 shows a portion of a medical system of the disclosure including a control device having a gestural interface; and

FIG. 2 is a block diagram showing the functional means of the control device having a gestural interface.

### DETAILED DESCRIPTION OF THE DISCLOSURE

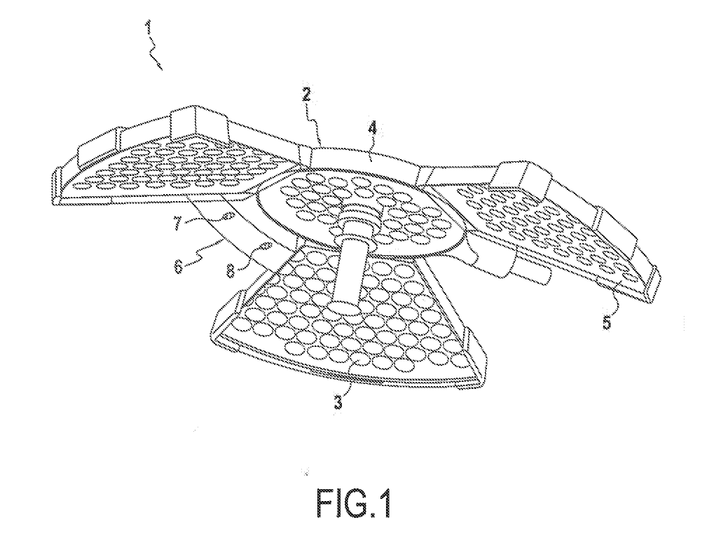

FIG. 1 shows an embodiment of a medical lighting system 1 of the disclosure. The medical lighting system 1 comprises, in particular, a set 2 of light sources 3, which are preferably sources delivering light fluxes that can be modulated, e.g. sources of the light-emitting diode (LED) type. The set 2 comprises: a central module 4 and optional auxiliary modules 5, e.g. three auxiliary modules. The auxiliary modules 5 are disposed around the central module 4. For example, the auxiliary modules 5 can be spaced apart uniformly around the central module 4, e.g. at 120° from one another, so as to obtain uniform illumination in all directions. Thus, the medical lighting system 1 may be a lighting system that makes it possible to illuminate a determined area without casting any shadows on it, and may be used in an operating theater for a surgical operation. The medical lighting system 1 may therefore be referred to as an “operating lighting system”.

Preferably, the medical lighting system 1 further comprises a specific optical surface mounted between at least some of the light sources 3 and the determined area. The specific optical surface may have various inclined facets facing light sources making it possible, in particular, to cause the size, and optionally the shape, of the determined area to vary by controlling, in individual or grouped manner, the light intensities emitted by said at least some of the light sources. Such an optical surface is, in particular, described in Patent Application EP 2 065 634. In which case, the auxiliary modules may be mounted in stationary manner on the central module 4.

In the remainder of the description below, it is considered that the lighting system 1 is an operating lighting system for which the user is a surgeon and the determined area is the illuminated area of the operative field.

The medical lighting system 1 may further comprise a movement device (not shown). The movement device may have two arms that are fastened together in pivotal manner. One of the arms may be fastened to a wall or to the ceiling, e.g. in pivotal manner, and the other arm may be fastened to the set of light sources 2, e.g. in pivotal manner. The movement device makes it possible to move and/or to point the set of light sources 2 in appropriate manner relative to the area to be illuminated.

In addition, the illumination properties of the light sources 3 may also be changed, on the instructions of the surgeon, in order to adapt the illuminated area of the operative field to suit the portion undergoing the operation. Thus, the illuminated area may be made larger or smaller, may be illuminated to a greater or lesser extent, or indeed may be illuminated by a light having a modified color temperature. In order to change the characteristics of the illuminated area, and in order to avoid having to manipulate a sterile control handle, the medical lighting system 1 further comprises a control device 6, mounted, for example, on the central module 4 of the lighting system 1, and comprising, in particular, two sensors 7 and 8.

The sensors 7, 8, e.g. two cameras, are preferably mounted on the set of light sources 2, and are pointed like the light sources, so as to point at the operative field, and more particularly the illuminated area on which the surgeon is working. The sensors 7, 8 are mounted some distance apart from each other, in such a manner as to have distinct detection zones but also a common portion referred to as the “common detection zone”. The use of two sensors for detecting elements in a common detection zone makes it possible, by stereoscopy, to determine the positions of the elements in three dimensions. In other words, the sensors 7, 8, mounted in a stereoscopic relationship, enable the control device 6 to have binocular vision of the illuminated area.

The control device 6 enables the user to control the lighting system 1, in particular the optical properties of the set of light sources 2, without requiring any contact with the lighting system 1. The control device 6 makes it possible, in particular, to detect and to interpret the movements of the surgeon so that the surgeon can modify the optical properties of the set of light sources 2 by means of gestures.

For example, in order to distinguish between firstly the control gestures and secondly the operative gestures made by the surgeon in the course of the operation, the control device 6 may detect all of the movements made within the common detection zone, but analyze only those made at a distance less than a determined distance from the two sensors 7, 8. For example, for a surgical operation for which the medical lighting system 1 is designed to illuminate optimally an area that is situated 1 meter away from a point lying vertically beneath it, the control device 6 may be configured to analyze only the movements made by the surgeon at a distance less than fifty centimeters from the sensors 7, 8, i.e. the movements made intentionally by the surgeon for controlling the medical lighting system 1.

Once within the analysis zone of the control device 6, the surgeon can then modify the optical properties of the set of light sources by making predefined gestures. For example, the surgeon may modify the level of illumination of the lighting system 1 by moving a hand, perpendicularly to the axis of the arm, in a plane parallel to the plane of the central module 4. A rightward movement may increase the level of illumination and a leftward movement may reduce it, or vice versa. Similarly, the surgeon may modify the focusing of the lighting system 1 by moving a hand upwards and downwards. An upward movement makes it possible to increase the focusing and a downward movement makes it possible to reduce it, or vice versa. Finally, the surgeon may modify the color temperature of the lighting system 1 by moving a hand, along the axis of the arm, in a plane parallel to the plane of the central module 4. A forward movement may increase the color temperature while a rearward movement may reduce it, or vice versa.

For each of these commands, the optical property may be changed with each movement of the surgeon. Alternatively, the control device 6 may be configured to increase or decrease the relevant optical property gradually for as long as the surgeon keeps the hand in the control position.

Each modification of the optical properties of the lighting system 1 may be indicated by a sound signal enabling the surgeon to know that the command has been taken into account by the control device 6. Similarly, when the surgeon places a hand within the analysis zone of the control device 6, said control device may emit a sound signal in order to indicate to the surgeon that movements that are made will be considered to be control gestures.

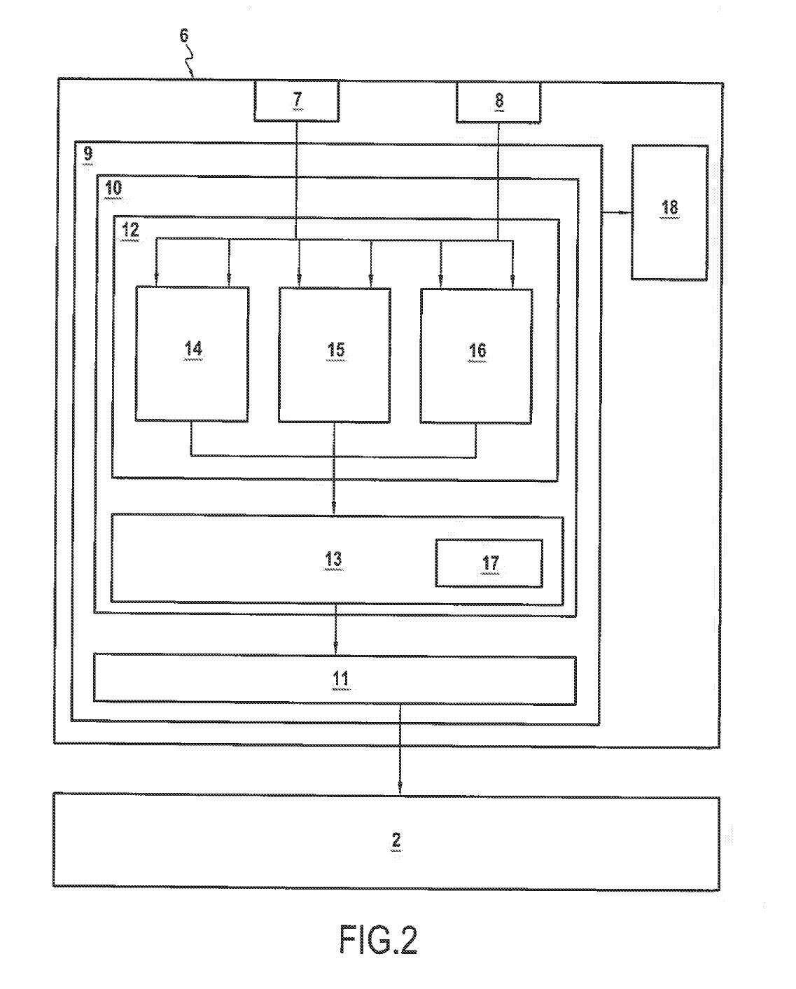

A block diagram of the functional means of the control device 6 is shown in FIG. 2.

The control device 6 thus includes analysis means 9 receiving as input the signals from the sensors 7, 8, and delivering as output modification signals for modifying the optical properties of the set of light sources 2. The modification signals may be electrical power supply signals for powering one or more light sources, in order to power them or not depending on the command from the user, or else they may be signals modifying in individual or grouped manner the power delivered to one or more light sources, in order to obtain, for each light source, a determined light intensity lying the range zero (light source off) to the maximum value. In particular, with the particular optical surface mentioned above, the size and the shape of the illuminated area of the operative field can thus be controlled without any mechanical action performed by the lighting system, but rather only by controlling, in individual or grouped manner, the light intensities of at least some of the light sources. The commands from the surgeon can thus be executed more rapidly, by electronic control, and without any intervention from a movement motor.

The analysis means 9 comprise gestural command identification means 10 for identifying the gestural command, and control means 11.

The gestural command identification means 10 receive as input the signals from the sensors 7, 8, and are configured to identify the gestural commands given by the surgeon within the common detection zone. The gestural command identification means 10 then transmit a control signal corresponding to the gestural command of the surgeon to the control means 11. The control means 11 make it possible to associate the received command signal with an optical property modification signal for modifying the optical properties of the set of light sources 2.

The gestural command identification means 10 make it possible to analyze the gestural commands from the surgeon in two main steps. They thus comprise gesture recognition means 12 that enable the gestures made by the surgeon to be identified in the signals coming from both of the sensors 7, 8, and command selection means 13 that enable the gestures identified by the gesture recognition means 12 to be associated with a determined command.

The gesture recognition means 12 receive as input the signals from both of the sensors 7, 8, and are configured to deliver one or more gesture identification signals to the command selection means 13. The gesture recognition means 12 may comprise three perception means in order to analyze the gestures made by the surgeon: the overall perception means 14, the dynamic perception means 15, and the structural perception means 16.

The overall perception means 14 receive as input the signals from both of the sensors 7, 8, and they are configured to deliver one or more first gesture identification signals, preferably in the form of space-time histograms. The overall perception means 14 make it possible, for different successive signals, to define values enabling the values of the signals from the sensors 7, 8 to be represented in the form of histograms. Such a device and such a method are described, in particular, in Patent Application FR 2 611 063.

Thus, the overall perception means 14 make it possible, by means of histograms, to identify elements in the signals coming from the sensors 7, 8. In addition, since the overall perception means 14 receive the signals from both of the sensors, they are also capable of identifying the elements present in the signals, in three dimensions.

The dynamic perception means 15 receive as input the signals from both of the sensors 7, 8, and they are configured to deliver one or more second gesture identification signals, preferably in the form of space-time histograms. The dynamic perception means 15 make it possible, for different successive signals, to detect variations in values in time and in space, and to represent them in the form of histograms. Such a device and such a method are described, in particular, in Patent Application FR 2 751 772.

Thus, the dynamic perception means 15 make it possible, by means of histograms, to identify movements of elements and their directions of movement in the signals coming from the sensors 7, 8. In addition, since the dynamic perception means 15 receive the signals from both of the sensors, they are also capable of identifying the movements of elements and the directions of movement, in three dimensions.

The structural perception means 16 receive as input the signals from both of the sensors 7, 8, and they are configured to deliver one or more third gesture identification signals, preferably in the form of space-time histograms. The structural perception means 16 make it possible, for various successive signals, to detect shapes and the associated directed edges, and to represent them in the form of histograms. Such a device and such a method are described, in particular, in Patent Application FR 2 858 447.

Thus, the structural perception means 16 make it possible, by means of histograms, to identify shapes and the directions in which they are pointing, in the signals coming from the sensors 7, 8. In addition, since the structural perception means 16 receive the signals from two sensors, they are also capable of identifying the shapes and the associated directions in which they are pointing, in three dimensions. Taking account of the shapes, in particular the shapes of the forearm, and of the directions in which they are pointing makes it possible to identify the surgeon's gesture regardless of the surgeon's position around the operative field. The control device is thus suitable for distinguishing between:
the command associated with a leftward movement by a first surgeon; and
the command associated with a rightward movement by a second surgeon facing the first surgeon;

even though both movements, which correspond to opposite commands, are made in the same direction.

The first, second, and third gesture identification signals are then transmitted to the command selection means 13. On the basis of the information contained in the various gesture identification signals, the command selection means 13 recognize the controlling element (the hand of the surgeon) present in the signals from the sensors 7, 8 and its three-dimensional path in the common detection zone. On the basis of this path, and of determined gestures associated with stored commands, the command selection means 13 are suitable for selecting the stored command corresponding to the detected gesture. The command selected in this way is then transmitted, in the form of a command signal, to the control means 11.

The commands associated with the detected gestures may, in particular, be parameterized as a function of the surgeon using the lighting system, or as a function of the type of surgical operation performed. Thus, the command selection means 13 may be parameterized to control a single optical property of the set of light sources 2, the various gestures making it possible to define the various amplitudes of variations in said optical property. Alternatively, the optical properties that are modifiable by the control device 6 may be modified as a function of the type of operation.

The command selection means 13 may preferably include activation means 17. The activation means 17 make it possible to associate a command with a detected gesture when said detected gesture satisfies a determined condition. For example, the activation means 17 may authorize a command corresponding to a determined gesture only if the gesture has been made in a defined portion of the common detection zone, e.g. at a determined distance from the illuminated area. Thus, only the gestures made at a distance, such as, by way of non-exclusive example, fifty centimeters, from the illuminated area, can result in a command. Alternatively the activation means 17 may authorize a command only if the gesture is made with a determined particularity, e.g. with only the index finger and the thumb being deployed.

The activation means 17 thus make it possible to distinguish between the gestures made for controlling the control device 6 and the gestures made by the surgeon in the course of the operation.

In order to enable the surgeon to know to what extent gestures are being taken into account by the control device 6, said control device may include sound information means 18 suitable for emitting a sound signal that is audible by the surgeon. The sound information means 18 may receive signals from the gestural command identification means, when a gesture is identified as corresponding to a command or else when the activation means 17 authorize a command. The sound information means 18 may also receive signals from the control means 11, e.g. when a modification signal for modifying the optical properties is sent. Thus, by means of the sound information means 18, the surgeon may know to what extent the surgeon's instructions are taken into account by the control device 6 or else whether, by mistake, he or she has activated the gesture recognition by an unintentional gesture.

For example, the sound information means 18 may emit a sound signal when the hand of the surgeon is situated fifty centimeters from the illuminated area: the sound signal indicates to the surgeon that the activation means 17 of the control device 6 are analyzing gestures in order to translate them into a command. Then, the sound information means 18 can emit a different sound signal each time a gestural command is detected and carried out by the control device 6. The surgeon then knows exactly the state of and the actions carried out by the control device 6.

The means 9, 10, 11, 12, 13, 14, 15, 16, 17 and/or 18 of the control device 6 can be separated means as shown in FIG. 2. Alternatively, the functionalities of several means 9, 10, 11, 12, 13, 14, 15, 16, 17 and/or 18 are integrated in one device. In addition, the functionalities of all or of some of the means 9, 10, 11, 12, 13, 14, 15, 16, 17 and/or 18 can be realized by computer programs, functions, partial programs or threads, which run in one or more processors.

Thus, the embodiments of the present disclosure enable a user to control a lighting system accurately and without requiring intervention from a third party, merely by making gestures without any physical contact with the lighting system. Such embodiments then enable the surgeon to control the lighting system without touching it, thereby avoiding problems of sterility during the operation. In addition, the system and method of the present disclosure remain flexible to use by enabling the commands to be adapted to suit the surgeon who is operating or to suit the type of operation being performed. Finally, by means of individual or grouped control of the light sources, it is also possible to obtain a modification in the illumination properties without moving the lighting system in full or in part, making it possible for the system to respond rapidly to the gestural command, and procuring a lighting system that is more reliable.

1. A medical lighting system comprising:
a set of light sources for illuminating a determined area and having one or more modifiable optical properties; and
a control device for controlling the set of light sources, in order to modify said one or more optical properties as a function of a command from a user;
wherein the control device is a control device having a gestural interface and comprising two sensors mounted some distance from each other, each sensor delivering a signal corresponding to a detection zone and the detection zones of the two sensors including a common detection zone for detecting a gestural command from the user; and wherein the control device is configured to modify said one or more optical properties as a function of said gestural command when the gestural command is given within the common detection zone and at a distance from the determined area that is greater than a determined value.

2. A medical lighting system according to claim 1, wherein the control device is configured to identify the gestural command and to deliver a control signal.

3. A medical lighting system according to claim 2, wherein the control device is configured to recognized the gesture from the user within the common zone of the two sensors.

4. A medical lighting system according to claim 3, wherein the control device is configured:
to identify the elements present within the common detection zone;
to identify movements within the common detection zone; and
to identify shapes within the common detection zone.

5. A medical lighting system according to claim 3, wherein the control device is configured to authorize identification of the command when the gestural command is given within the command detection zone and at a distance from the determined area that is greater than a determined value.

6. A medical lighting system according to claim 2, wherein the control device is configured to modify said one or more optical properties.

7. A medical lighting system according to claim 1, wherein the control device is configured to emit a sound signal that is audible by the user and that indicates that a gestural command has been detected, or that a gestural command is expected.

8. A medical lighting system according to claim 7, wherein the control device is configured to emit a sound signal that is audible by the user when the control device authorizes identification of the command.

9. A control method for controlling a medical lighting system by means of a gestural interface, the medical lighting system comprising a set of light sources that are configured to illuminate a determined area and that have one or more modifiable properties, the method comprising the following successive steps:
a) a detection step of detecting a gestural command of a user within a detection zone that is common to two different detection zones; and then
b) an analysis step of analyzing said gestural command in order to modify said one or more optical properties as a function of said gestural command when the gestural command is given within the common detection zone and at a distance from the determined area that is greater than a determined value.

10. A control method according to claim 9, wherein the analysis step comprises:
b1 a gestural command identification step of identifying said gestural command.

11. A control method according to claim 10, wherein the gestural command identification step b1 for identifying said gestural command comprises:
b11) a gesture recognition step of recognizing the gesture; and then
b12) a command selection step of selecting the command corresponding to the gesture identified in step b11.

12. A control method according to claim 11, wherein the gesture recognition step b11 for recognizing the gesture comprises:
overall perception identifying the elements present within the common detection zone;
dynamic perception identifying movements within the common detection zone; and
structural perception identifying shapes within the common detection zone.

13. A control method according to claim 11, wherein the command selection step comprises an activation step authorizing identification of the command when the gestural command is given within the common detection zone and at a distance from the determined area that is greater than a determined value.

14. A control method according to claim 10, wherein the analysis step comprises an optical property modification step of modifying said one or more optical properties as a function of said gestural command.

15. A control method according to claim 9, also comprising a sound information step during which a sound signal that is audible by the user is emitted for indicating that a gestural command has been detected, or that a gestural command is expected.

16. A control method according to claim 15, wherein the sound information step emits a sound signal that is audible by the user when the activation step authorizes identification of the command.

17. An operating lighting system comprising a medical lighting system according to claim 1.
